(19) United States
(12) Patent Application Publication
(10) Pub. No.: US 2006/0059247 A1
(43) Pub. Date: Mar. 16, 2006

(54) Automatic simultaneous entry of values in multiple web page fields

(75) Inventors: Kumar Marappan, Round Rock, TX (US); Kanmani Nachimuthu, Austin, TX (US); Lakshmi Potluri, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/942,429

(22) Filed: Sep. 16, 2004

(51) Int. Cl. G06F 15/16

(52) U.S. Cl. 709/219

(57) ABSTRACT

A method, system, and program for automatic simultaneous entry of values in multiple web page fields are provided. Responsive to detecting a single action selection by a user to fill multiple fields of a web page, wherein each of the fields is associated with one from among multiple field descriptors within a source code for the web page, a field copy controller scans multiple lines of text copied into a local memory to identify text tags that match the field descriptors. Then, the field copy controller automatically fills in the fields within the web browser with the values from the lines of text, wherein each of the values is associated with one from among multiple text tags matching the field descriptors associated with the fields, such that multiple fields of a web page are automatically filled in responsive to only a single action by a user.

### BACKGROUND OF THE INVENTION

1. Technical Field

The present invention relates in general to improved copy and paste functions and in particular to improved copy and paste functions for multiple fields of a web page. Still more particularly, the present invention relates to automatically and simultaneously pasting into multiple fields of a web page from a single text file or copying out from multiple fields of a web page to a single text file, responsive to a single action selection by a user.

2. Description of the Related Art

Dynamic web pages often include fields into which a user may enter information. For example, an electronic commerce (e-commerce) web page may include fields into which a user enters a user identifier and password, wherein upon entry of a registered user identifier and password, the web host allows the user access to additional, secured information. In another example, an e-commerce web page may include fields into which a user enters shipping information, credit card information, and other personal information when the user orders a product or service.

Traditionally, many operating systems provide copy and paste functions. To use a traditional copy function, a user selects a portion of the data within the display area and enters a command to copy that portion of data into local memory. Then, the user can later select to paste the copied portion of data out of local memory and into the display area. While the traditional copy and paste functions are useful in a word processing environment, copy and paste functions are not as useful in a dynamic web page environment. First, a user cannot simultaneously select multiple fields, and thus the user cannot simultaneously copy the values out of multiple fields. Second, even if the user copies a single field, data displayed within fields of a web page is supported by underlying data, typically referred to as tags and labels, and the copy of the field value will not reflect the underlying data. Third, a user cannot simultaneously paste data into multiple fields, and thus for the user to fill multiple fields using the traditional copy and paste functions, the user must make a selection to copy and paste for each field or manually enter the information in each field.

When an application developer develops a dynamic web page, it is common for the developer to test how the web page responds to information entered in the multiple fields of the web page as the developer debugs the web page. Because of the current limitations of traditional copy and paste functions, in testing a web page, it is common for a developer to manually re-enter the same information over and over again in each of the multiple fields of the web page. In one example, an application developer who creates and authenticates users to dynamic web pages may manually reenter the same user identifier in a user identification field and the same password in a password field for each test sequence. Manually re-entering the same test data in multiple fields is time consuming and creates repetitive work stress. Further, even if the developer uses a copy and paste function to enter the test data, the developer must repetitively select the copy and paste function for each field into which information is entered.

When a user accesses different web sites, each web site may require the user to re-enter the same information. For example, each web site through which a user purchases a product may require the user to enter an address into multiple fields, such as street address, city, state, and zip code fields. Some web sites implement cookies that reside on the user's computer and store information entered by the user, such that when the user returns to that particular site, the web browser retrieves the information in the cookie and automatically enters the information into the fields of the web site. However, cookies are limited because an individual cookie must be created for each web site by the web site and the cookie is stored on a user's computer. Thus, a user must still enter the same information at each web site, at least a first time, to receive a cookie. In addition, the user can only control whether or not a cookie is received and not the actual contents of the cookie. Further, use of a cookie for debugging or testing a web site is limited because the developer cannot control what information is in the cookie and cannot control when the web browser enters the cookie information into the web page fields.

Therefore, in view of the foregoing, there is a need for a method, system, and program for enabling the user to control automatic and simultaneous paste in of values into multiple fields in a web page through a single action selection by the user. In particular, it would be advantageous to provide a method, system, and program for enabling the user to enter information for multiple fields of a web page into a text editor and enable the user through a single action within the web browser to select to fill in multiple fields of a web page with the information entered through the text editor. Further, there is a need for a method, system, and program for enabling the user to copy out multiple fields of a web page and the underlying field descriptors for those fields to a single text file through a single action selection by the user.

### SUMMARY OF THE INVENTION

Therefore, the present invention provides improved copy and pasting and in particular provides improved copying and pasting for fields of a web page. Still more particularly, the present invention provides for automatically filling in multiple fields of a web page from a text file responsive to a single action selection by a user.

According to one aspect, responsive to detecting a single action selection by a user to fill multiple fields of a web page, wherein each of the fields is associated with one from among multiple field descriptors within a source code for the web page, a field copy controller scans multiple lines of text copied into a local memory to identify text tags that match the field descriptors. Then, the field copy controller automatically and simultaneously fills in the fields within the web browser with the values from the lines of text, wherein each of the values is associated with one from among multiple text tags matching the field descriptors associated with the fields, such that multiple fields of a web page are automatically and simultaneously pasted in responsive to only a single action by a user.

A user may enter the multiple lines of text through a text editor. Then, responsive to the user selecting to copy the multiple lines of text within the text editor into local memory, the field copy controller enables the option to make the single action selection to fill multiple fields of a web page.

When the field copy controller detects the single action selection to fill multiple fields of a web page, the field copy controller may detect a position of a pointer in proximity to a closest field from among all the fields within the web page. Then, the field copy controller automatically fills in only those fields starting from the closest field and continuing with the fields following the closest field.

The web page is displayed within a web browser. The web browser may incorporate the field copy controller or the web browser may access the field copy controller as a plug-in. The web browser includes a menu option to automatically fill in fields that the user may select as the single action selection.

The text tags and the values may be formatted in different font languages. For example, a text tag may be formatted in an English font and a value may be formatted in a Japanese font. Further, a single line may include multiple text tags and values.

According to another aspect, responsive to a single action selection to copy out multiple fields within a web page, wherein each of the fields is associated with one from among multiple field descriptors within a source code for the web page, a field copy controller creates a line of text for each field descriptor with the value filled into the field associated with the field descriptor. The field copy controller simultaneously outputs the lines of text to a single text file, such that only a single action by a user is required for multiple fields in a web page to be simultaneously copied out to a text file.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a network system for facilitating delivery of web pages from server systems to client systems in one embodiment of the present invention;

FIG. 3 is a block diagram depicting the field copy controller within a web browser that enables the automatic single action multiple field copy in and copy out functions;

FIG. 4 is an illustrative example depicting an example of automatic fill-in of multiple fields in a web browser in accordance with the method, system, and program of the present invention;

FIG. 5 is an illustrative example depicting an example of automatic copy out of multiple fields in accordance with the method, system, and program of the present invention;

FIG. 6 is a high level logic flowchart depicting a process and program for controlling the automatic fill in of fields within a web browser in accordance with the method, system, and program of the present invention; and

FIG. 7 is a high level logic flowchart depicting a process and program for controlling the automatic copy out of fields within a web browser to a text file in accordance with the method, system, and program of the present invention.

### DETAILED DESCRIPTION OF THE PREFERRED EMBODIMENT

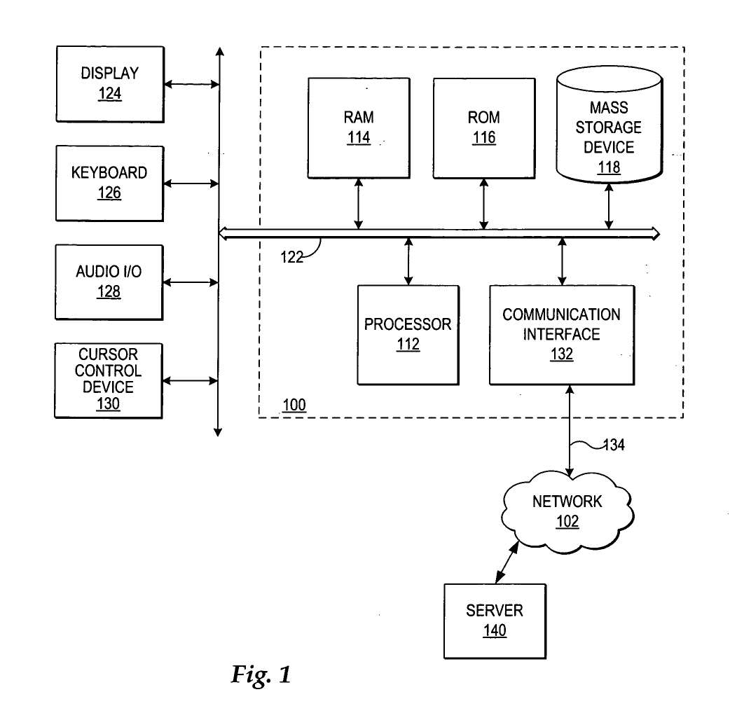

Referring now to the drawings and in particular to FIG. 1, there is depicted one embodiment of a system through which the present method, system, and program may be implemented. A variety of systems, including a variety of computing systems and electronic devices, may execute the present invention.

Computer system 100 includes a bus 122 or other communication device for communicating information within computer system 100, and at least one processing device such as processor 112, coupled to bus 122 for processing information. Bus 122 may include low-latency and higher latency paths connected by bridges and adapters and controlled within computer system 100 by multiple bus controllers. When implemented as a server system, computer system 100 typically includes multiple processors designed to improve network servicing power.

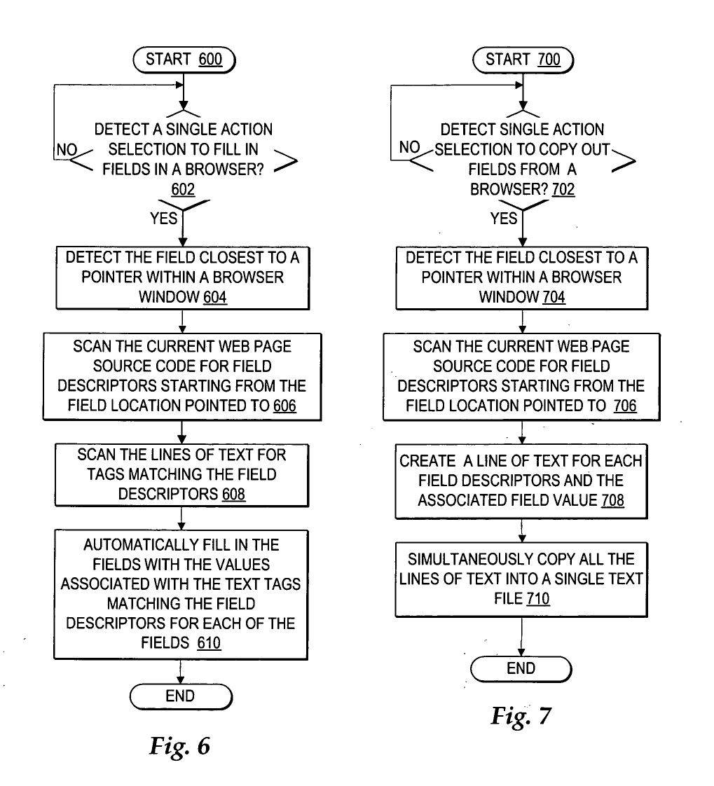

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system may provide a graphical user interface (GUI). In one embodiment, operating system or application software contains machine executable instructions that when executed on processor 112 carry out the operations depicted in the flowcharts of FIGS. 6, 7, and other operations described herein. Specific hardware components that contain hardwired logic for performing the steps or any combination of programmed computer components and custom hardware components may also perform the steps of the present invention.

The present invention may also be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or an Internet Service Provider (ISP). In particular, network link 134 may provide wired and/or wireless network communications to one or more networks.

Network link 134 provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

In addition, computer system 100 typically includes multiple peripheral components that facilitate communication. These peripheral components are connected to multiple controllers, adapters, and expansion slots coupled to one of the multiple levels of bus 122. For example, an audio input/output (I/O) device 128 is connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

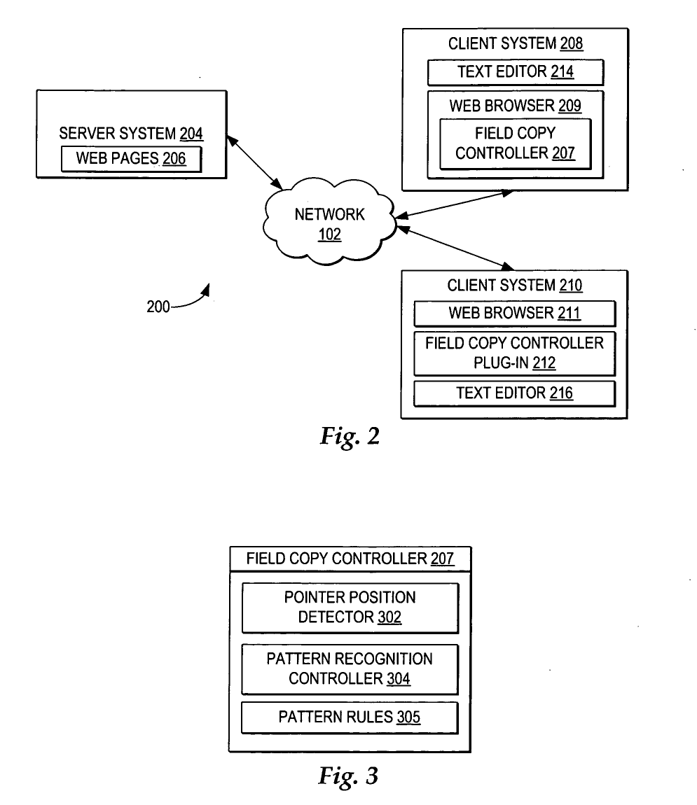

With reference now to FIG. 2, a block diagram depicts a network system for facilitating delivery of web pages from server systems to client systems in one embodiment of the present invention. Distributed system 200 is a network of computing devices in which one embodiment of the invention may be implemented. It will be understood that the present invention may be implemented in other embodiments of systems enabled to communicate via a connection.

In the embodiment, distributed system 200 contains network 102, which is the medium used to provide communications links between various devices and computers connected together within distributed system 200. Network 102 may include permanent connections such as wire or fiber optics cables, temporary connections made through telephone connections and wireless transmission connections.

In addition, in the embodiment, distributed system 200 includes client systems 208 and 210. Client systems 208 and 210 may request access to web pages, such as web pages 206, from a server system, such as server system 204, via network 102. Further, although not depicted, client systems 208 and 210 may serve web pages to one another through a peer-to-peer network or other communication channel.

When implementing a client/server environment, many network architectures may incorporate distributed system 200. In one example, distributed system 200 is implemented through the Internet with network 102 representing a worldwide collection of networks and gateways that use the TCP/IP suite of protocols to communicate with one another. Millions of high-speed data communication lines between major nodes or host computers enable the Internet. In another example, distributed system 200 is implemented as an intranet, a local area network (LAN), or a wide area network (WAN). Moreover, distributed system 200 may include networks employing alternatives to a traditional client/server environment, such as a grid computing environment. In addition, other types of environments, such as a telephony based environment may be implemented within communication system 200.

In one embodiment, server system 204 delivers web pages 206 via network 102 to client systems 208 and 210 by transferring the source code and other data for each web page. Client systems 208 and 210 may include browser applications, such as web browsers 209 and 211 for providing an interactive interface for displaying web pages. In particular, web pages may include fields into which a user enters data and web browsers 209 and 211 enable transmission of the entered data to server system 204.

As will be described in detail with reference to FIG. 3, web browsers 209 and 211 include field copy controllers 207 and 212 that provide for automatic paste in and copy out for multiple fields displayed in a web page through a single action selection by the user. In one example, a user may enter a single key function or make a single menu selection within the display interface of web browsers 209 and 211 to invoke the automatic paste in to multiple fields from text available in a local memory or the automatic copy out of multiple field values and the underlying field descriptors to a text file. Also, according to one advantage, a web browser may incorporate a field copy controller, such as field copy controller 207 or a web browser may include the field copy controller as an add-on, such as field copy controller plug-in 212.

The term “local memory”, as used herein, refers generally to a physical memory, such as RAM 114, and more specifically to the memory location into which data that is copied, using a traditional copy function, is placed. Further, the term “local memory” may include data displayed within a text editor that has not yet been copied using a traditional copy function. The term “traditional copy function”, as used herein, refers generally to the function provided by many operating systems where a user can select a portion of data displayed in an interface and select to make a copy of that selected portion of data into a local memory. The traditional copy function is typically coupled with a traditional paste function that a user can select to retrieve the copy of the selection portion of data from local memory into a currently pointed to area within a display interface.

The term “field descriptors”, as used herein, refers generally to the web page coding associated with a field. For example, a field descriptor for a field may include a tag, such as “<input type=“text” name=“username”>,” which is the notation in the web page code that identifies the kind and type of field. In another example, a field descriptor for a field may include a label, such as “Username:”, which is a field notation made visible to the user in the browser window.

Text editors 214 and 216 provide interfaces through which a user may enter text and copy that text into local memory using the traditional copy function. Text editors 214 and 216 include any application enabling a user to enter text which can be copied into a local memory using a traditional copy function. For example, text editors 214 and 216 may include word processors or notepad applications.

Referring now to FIG. 3, there is depicted a block diagram of the controllers within a web browser including a field copy controller that enables the automatic single action multiple field copy in and copy out functions. As depicted, field copy controller 207 includes a pointer position detector 302. Pointer position detector 302 detects the position of a pointer within a web browser interface in relation to the fields displayed within the web browser interface. In particular, pointer position detector 302 detects which field the pointer is closest too and designates that field as the starting field for automatic multiple field paste in and copy out functions. As a result, by positioning the pointer using a mouse or other input device, a user may select to only automatically fill-in or copy out those fields displayed within a particular portion of the web browser.

In addition, as depicted, field copy controller 207 includes a pattern recognition controller 304. Pattern recognition controller 304 scans the source code for a web page to identify field descriptors, such as tags and labels, and then scans the text copied into a local memory to identify the same or text tags that are similar to the field descriptors. In one example, pattern recognition controller 304 matches a label within source code specified as “username:” and the text tag within the text copied into local memory specified as “username:”. In another example, not depicted, pattern recognition controller 304 matches a tag within source code specified as “name=username” and the text tag within the text copied into local memory specified as “user:”.

In particular, pattern recognition controller 304 scans source code to identify field descriptors based on pattern rules 305. Pattern rules 305 may include pre-determined tag, label, and other field descriptor patterns. Further, a user may specify tag, label, and other field descriptor patterns. Further, pattern recognition controller 304 may detect when a user changes the values automatically filled into fields and infer a pattern for the field descriptors associated with fields that were improperly filled in.

In addition, pattern recognition controller 304 scans the text copied into the local memory for values associated with each text tag. For example, if a line of the text copied into the local memory is “username: Janie”, then pattern recognition controller 304 recognizes “username:” as the text tag as “Janie” as the value. It is important to note that in addition to text based values, a user may enter other types of data, such as graphics and voice samples, and pattern recognition controller 304 recognizes these types of data as values.

Field copy controller 207 also detects a user's single action selection to automatically fill-in multiple fields of a web page from local memory or to automatically copy out multiple fields of a web page to local memory and controls performance of the automatic copy in or copy out of multiple fields.

In particular, when a user makes a single action selection to automatically fill-in multiple fields, field copy controller 207 receives the pointer position from pointer position detector 302 and the matching text tags and values from pattern recognition controller 304. Field copy controller 207 controls filling in the fields of the web browser with the values associated with text tags matching the field descriptors for each field, starting with the field closest to the pointer.

In addition, in particular, when a user makes a single action selection to automatically copy out multiple fields of a web page to local memory, field copy controller 207 receives the pointer position from pointer position detector 302 and the field descriptors and field values from pattern recognition controller 304. Field copy controller 207 controls output of the field descriptors and field values into a local memory or directly into a text file.

It is important to note that while the functional components of field copy controller 207 are specifically described, field copy controller plug-in 212 may include similar functional components as those described for field copy controller 207.

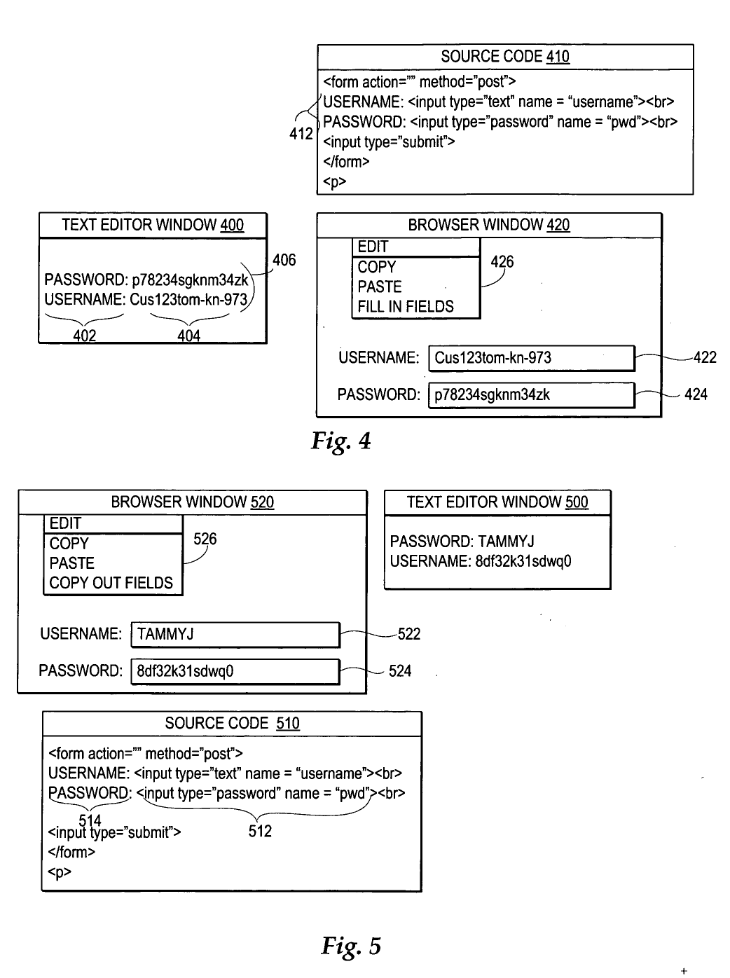

With reference now to FIG. 4, there is depicted an illustrative example of an automatic fill-in of multiple fields in a web browser in accordance with the method, system, and program of the present invention. As illustrated, a text editor window 400 includes two lines within a text 406. A first portion of each line of text 406 includes a text tag, as indicated at reference numeral 402. In particular, the text tags illustrated are “password:” and “username:”. A second portion of each line of text 406 includes a value, as indicated at reference numeral 404. In particular, the values illustrated are “p78234sgknm34zk” and “Cus123tom-kn-973”. It is important to note that while in the example the value in text 406 follows the text tag, in alternate examples, a text tag may follow a value. Further, in alternate examples, a single line may include multiple text tags and values.

In the example depicted, the font language used in text 406 to display the text tags indicated at reference numeral 402 is the same as the font language used to displayed the values indicated at reference numeral 404. In alternate embodiments, however, each of the text tags and values may be displayed in different fonts languages. For example, a line of text may include a text tag of “username:” in one font language, such as English, and the value in a different font language, such as Japanese. Advantageously, by enabling a user to format text 406 in different font languages, a user may format the values once using one language package and then not need to return to that language package when entering the values into fields of the web page.

A source code 414 illustrates the source code for the web page displayed in a browser window 420. It is important to note that the web browser may access source code 414 for the web page displayed in browser window 420 from a network location, such as server system 204, or from a local location.

In source code 414, the field descriptors, indicated at reference numeral 412, include labels “username:” and “password:” and tags “<input type=“text” name=“username”>” and “<input type=“password” name=“pwd”>.” Corresponding to the source code, browser window 420 displays the code labels “username:” and “password:” and fields 422 and 424 for entry of values.

According to an advantage of the invention, a user may request automatic fill-in of fields 422 and 424 from text 406 through a single action. To make the single action selection, a user may enter a key command, voice command, or provide other types of input. In addition, as depicted in browser window 420, a user may make the single action selection by selecting a “fill in fields” option from pull down menu 426. It is important to note that browser window 420 may include the “fill in fields” option in pull down menu 426 from a browser plug-in that enables multiple field paste in and copy out.

Responsive to detecting a single action selection for automatic fill-in of fields 422 and 424, pattern recognition controller 304 scans source code 410 for field descriptors. In the example, pattern recognition controller 304 detects field descriptors 412, and in particular detects tags and labels within field descriptors 412. Next, pattern recognition controller 304 scans text 406 within text editor window 400 to detect the same or similar text tags as the field descriptors detected in source code 414. Alternatively, text 406 may be copied into local memory and pattern recognition controller 304 scans text 406 within local memory to detect the same or similar text tags as field descriptors 412 detected in the source code.

Once pattern recognition controller 304 detects the same or similar text tags within text 406 as field descriptors 412, field copy controller 207 controls filling in fields 422 and 424 with values depicted at reference numeral 404 associated with text tags depicted at reference numeral 402 that match the field descriptors depicted at reference numeral 412. As illustrated, because pattern recognition controller 304 detects the text tags and values within text 406, the order in which the text tags are listed in text 406 need not match the order in which tags, labels, and other field descriptors are listed in source code 414.

Referring now to FIG. 5, there is depicted an illustrative example of an automatic copy out of multiple fields in accordance with the method, system, and program of the present invention. As depicted, a browser window 520 displays contents based on source code 510. In particular, browser window 520 displays fields 522 and 524, which correspond to the code tags “username:” and “password:” from source code 510.

According to an advantage of the invention, a user may request automatic copy out of fields 522 and 524 to text editor window 500 through a single action. To make the single action selection, a user may enter a key command, voice command, or provide other types of input. In addition, as depicted in browser window 520, a user may make the single action selection by selecting a “copy out fields” option from pull down menu 526. It is important to note that browser window 520 may include the “copy out fields” option in pull down menu 526 from a browser plug-in that enables multiple field copying.

Responsive to detecting a single action selection for automatic copy out of fields 522 and 524, pattern recognition controller 304 scans the source code within source code window 510 for tags, labels, and other field descriptors. In the example, pattern recognition controller 304 detects field descriptors, including tags 512 and labels 514. Next, field copy controller 207 controls output of the field labels and field values to text editor window 500 by creating a text line for each field label and field value and simultaneously outputting the text lines into a single file. In particular, field copy controller 207 may automatically open a window within a designated text editor or may prompt a user to select a text editor. Alternatively, field copy controller 207 may copy the field labels and field values into local memory from which a user may select to paste the contents into a text editor.

It is important to note that field copy controller 207 may prompt a user to select which field descriptors and field values to copy. Further, it is important to note that field copy controller 207 may also prompt a user to select whether to copy the field descriptors and field values into a new text editor file or whether to add the field descriptors and field values into a cumulative file. For example, a user may select to accumulate all field entries across multiple web pages into a single, cumulative text file. In particular, by accumulating all field entries in a single, cumulative text file, pattern recognition controller 304 is more likely to detect text tag entries in the cumulative text file that match the field descriptors in the source code of a web page when a user requests to fill-in the fields of a web page from the cumulative text file.

With reference now to FIG. 6, there is depicted a high level logic flowchart of a process and program for controlling the automatic fill in of fields within a web browser in accordance with the method, system, and program of the present invention. As depicted, the process starts at block 600 and thereafter proceeds to block 602. Block 602 depicts a determination whether a single action selection to fill in fields in a browser is detected. If a single action selection to fill in fields in a web page displayed within a browser is detected, then the process passes to block 604. Block 604 depicts detecting the field closest to a pointer within a browser window. Next, block 606 depicts scanning the current web page source code for field descriptors starting from the closest field pointed to by the pointer. In particular, the pattern recognition controller is able to detect textual patterns within source code that indicate tags, labels, and other field descriptors. Thereafter, block 608 depicts scanning the lines of text within a text editor window or a local memory for text tags matching the field descriptors. Next, block 610 depicts automatically filling in the fields within the web page with the values associated with the text tags that match the field descriptors for each of the fields, and the process ends.

Referring now to FIG. 7, there is depicted a high level logic flowchart of a process and program for controlling the automatic copy out of fields within a web browser to a text file in accordance with the method, system, and program of the present invention. As depicted, the process starts at block 700 and thereafter proceeds to block 702. Block 702 depicts a determination whether a single action selection to copy out fields from the web page displayed in a browser is detected. If a single action selection to copy out fields from a browser is detected, then the process passes to block 704. Block 704 depicts detecting the field closest to a pointer within the browser window. Next, block 706 depicts scanning the current web page source code for field descriptors starting from the field location pointed to by the pointer. Thereafter, block 708 depicts creating a line of text describing each field descriptor and associated field value. Alternatively, a user may select to copy out a selection of the field descriptors and field values. Next, block 710 depicts simultaneously copying all the lines of text to a text file, and the process ends.

While the invention has been particularly shown and described with reference to a preferred embodiment, it will be understood by those skilled in the art that various changes in form and detail may be made therein without departing from the spirit and scope of the invention.

What is claimed is:

1. A computer-implemented method for automatically filling in a plurality of fields of a web page, said method comprising:
responsive to a single action selection to fill in a plurality of fields within a web page, wherein each of said plurality of fields is associated with one from among a plurality of field descriptors within a source code for said web page, scanning a plurality of lines of text copied into a local memory to identify a plurality of text tags matching said plurality of field descriptors; and
automatically filling in said plurality of fields with a plurality of values from said plurality of lines of text, wherein each of said plurality of values from said plurality of lines of text is associated with one from among a plurality of text tags matching each of said plurality of field descriptors associated with said plurality of fields, such that only a single action by a user is required for said plurality of fields within said web page to be automatically filled in.

2. The computer-implemented method according to claim 1 for automatically filling in a plurality of fields of a web page, further comprising:
responsive to a user selection to copy a plurality of lines of text within a text editor into said local memory, enabling said user to make said single action selection to fill in said plurality of fields within said web page from said local storage.

3. The computer-implemented method according to claim 1 for automatically filling in a plurality of fields of a web page, wherein automatically filling in said plurality of fields with a plurality of values from said plurality of lines of text, further comprises:
responsive to said single action selection to fill in said plurality of fields within said web page, detecting a position of a pointer in proximity to a closest field from among said plurality of fields within a display area; and
automatically filling in only said closest field and a selection of said plurality of fields following said closest field.

4. The computer-implemented method according to claim 1 for automatically filling in a plurality of fields of a web page, further comprising:
displaying said plurality of fields of said web page within a web browser;
enabling said user to invoke said single action selection within a menu of said web browser.

5. The computer-implemented method according to claim 1 for automatically filling in a plurality of fields of a web page, wherein said plurality of text tags are formatted in a first font language and said plurality of values are formatted in a second font language.

6. The computer-implemented method according to claim 1 for automatically filling in a plurality of fields of a web page, wherein responsive to a single action selection to fill in a plurality of fields within a web page, wherein each of said plurality of fields is associated with one from among a plurality of field descriptors within a source code for said web page, scanning a plurality of lines of text copied into a local memory for a plurality of text tags matching said plurality of field descriptors, further comprises:
detecting said plurality of field descriptors within said source code for said web page by comparing said source code with a plurality of field descriptor pattern rules.

7. The computer-implemented method according to claim 1 for automatically filling in a plurality of fields of a web page, wherein said plurality of field descriptors further comprise at least one from among a plurality of tags and a plurality of labels.

8. A computer system for automatically filling in a plurality of fields of a web page, comprising:
a local storage for temporarily storing a plurality of lines of text, wherein said plurality of lines of text comprise a plurality of values associated with a plurality of text tags;
a web browser for displaying a web page comprising a plurality of fields, wherein each of said plurality of fields is associated with one from among a plurality of field descriptors within a source code for said web page;
said web browser further comprising:
means for scanning said plurality of lines of text copied into a local storage to identify said plurality of text tags matching said plurality of field descriptors and to identify said plurality of values associated with said plurality of text tags, responsive to a single action selection to fill in said plurality of fields within said web page; and
means for automatically filling in said plurality of fields with said plurality of values scanned from said plurality of lines of text.

9. The computer system according to claim 8 for automatically filling in a plurality of fields of a web page, further comprising:
means, responsive to a user selection to copy said plurality of lines of text within a text editor into said local memory, for enabling said user to make said single action selection to fill in said plurality of fields within said web page from said local storage.

10. The computer system according to claim 8 for automatically filling in a plurality of fields of a web page, wherein automatically filling in said plurality of fields with a plurality of values scanned from said plurality of lines of text, further comprises:
means, responsive to said single action selection to fill in said plurality of fields within said web page, for detecting a position of a pointer in proximity to a closest field from among said plurality of fields within a display area; and
means for automatically filling in only said closest field and a selection of said plurality of fields following said closest field.

11. The computer system according to claim 8 for automatically filling in a plurality of fields of a web page, said web browser further comprising:
a menu option for enabling said user to invoke said single action selection.

12. The computer system according to claim 8 for automatically filling in a plurality of fields of a web page, wherein said plurality of text tags are formatted in a first font language and said plurality of values are formatted in a second font language.

13. The computer system according to claim 8 for automatically filling in a plurality of fields of a web page, said web browser further comprising:
means for detecting said plurality of field descriptors within said source code for said web page by comparing said source code with a plurality of field descriptor pattern rules.

14. The computer system according to claim 8 for automatically filling in a plurality of fields of a web page, wherein said plurality of field descriptors further comprise at least one from among a plurality of tags and a plurality of labels.

15. A computer program product, residing on a computer readable medium, for automatically filling in a plurality of fields of a web page, said computer program product comprising:
means, responsive to a single action selection to fill in a plurality of fields within a web page, wherein each of said plurality of fields is associated with one from among a plurality of field descriptors within a source code for said web page, for controlling a scan of a plurality of lines of text copied into a local memory to identify a plurality of text tags matching said plurality of field descriptors; and
means for automatically filling in said plurality of fields with a plurality of values from said plurality of lines of text, wherein each of said plurality of values from said plurality of lines of text is associated with one from among a plurality of text tags matching each of said plurality of field descriptors associated with said plurality of fields.

16. The computer program product according to claim 15 for automatically filling in a plurality of fields of a web page, said computer program product further comprising:
means, responsive to a user selection to copy a plurality of lines of text within a text editor into said local memory, for enabling said user to make said single action selection to fill in said plurality of fields within said web page from said local storage.

17. The computer program product according to claim 15 for automatically filling in a plurality of fields of a web page, wherein said means for automatically filling in said plurality of fields with a plurality of values from said plurality of lines of text, further comprises:
means, responsive to said single action selection to fill in said plurality of fields within said web page, for controlling detection of a position of a pointer in proximity to a closest field from among said plurality of fields within a display area; and
means for automatically filling in only said closest field and a selection of said plurality of fields following said closest field.

18. The computer program product according to claim 15 for automatically filling in a plurality of fields of a web page, said computer program product further comprising:
means for enabling a display of said plurality of fields of said web page within a web browser;
means for enabling said user to invoke said single action selection within a menu of said web browser.

19. The computer program product according to claim 15 for automatically filling in a plurality of fields of a web page, said computer program product further comprising:
means for enabling detection of said plurality of field descriptors within said source code for said web page by comparing said source code with a plurality of field descriptor pattern rules.

20. A computer-implemented method for automatically copying out a plurality of fields of a web page, said method comprising:
responsive to a single action selection to copy out a plurality of fields within a web page, wherein each of said plurality of fields is associated with one from among a plurality of field descriptors within a source code for said web page, creating a particular line of text from among a plurality of lines of text for each of said plurality of field descriptors with one from among a plurality of values filled into an associated one of said plurality of fields; and
automatically copying said plurality of lines of text to a single text file, such that only a single action by a user is required for said plurality of fields and said plurality of field descriptors within said web page to be simultaneously copied out.

21. The computer-implemented method according to claim 20 for automatically copying out a plurality of fields of a web page, wherein creating a particular line of text from among a plurality of lines of text for each of said plurality of field descriptors with one from among a plurality of values filled into an associated one of said plurality of fields, further comprises:
detecting a position of a pointer in proximity to a closest field from among said plurality of fields within a display area; and
automatically creating said particular line of text from among said plurality of lines of text starting with said closest field and a selection of said plurality of fields following said closest field.

22. The computer-implemented method according to claim 20 for automatically copying out a plurality of fields of a web page, further comprising:
displaying said plurality of fields of said web page within a web browser;
enabling said user to invoke said single action selection within a menu of said web browser.

23. The computer-implemented method according to claim 20 for automatically copying out a plurality of fields of a web page, further comprising:

24. The computer-implemented method according to claim 20 for automatically copying out a plurality of fields of a web page, further comprising:
detecting said plurality of field descriptors within said source code for said web page by comparing said source code with a plurality of field descriptor pattern rules.
